(19) United States
(12) Patent Application Publication
(10) Pub. No.: US 2003/0138256 A1
(43) Pub. Date: Jul. 24, 2003

(54) System and method for providing transmission capacity on a data transmission path

(76) Inventor: Michael Rasztovits-Wiech, Wien (AT)

Correspondence Address: Bell, Boyd & Lloyd LLC, P.O. Box 1135, Chicago, IL, 60690-1135, US

(21) Appl. No.: 10/348,130

(22) Filed: Jan. 21, 2003

(30) Foreign Application Priority Data
Jan. 21, 2002 (DE) 102 02 142.2

(51) Int. Cl. H04B 10/18

(52) U.S. Cl. 398/147

(57) ABSTRACT

A system and method are disclosed for providing transmission capacity on a data transmission path wherein data transmission capacity is provided in a user-related manner on the transmission path by limiter units.

### BACKGROUND OF THE INVENTION

The present invention relates to a system and associated methods for providing data transmission capacity on a data transmission path disposed between at least one transmit unit and receive unit.

Telecommunications fixed-network operators with their own transmission media, such as optical fiber cables, do not always use all the transmission media available to them; in particular, transmission lines. Unused transmission capacities in the case of optical fibers may then, for example, be leased to third parties. On an optical fiber transmission path not terminated by transmission devices, also referred to below as dark fiber, a transmission capacity of 1.6 Tbit/s can be achieved, for example, with single-mode fibers.

An object of the present invention is to provide a system and a method which prevent misuse of free data transmission capacities of a transmission medium.

### SUMMARY OF THE INVENTION

Accordingly, in an embodiment of the present invention, a system is disclosed for providing data transmission capacity on a data transmission path disposed between at least one transmit unit and at least one receive unit, wherein the system includes at least one limiter unit provided between the transmit unit and the receive unit, the limiter unit being supplied with a data stream exchange between the transmit unit and the receive unit and limiting the data transmission capacity in a user-related manner.

In an embodiment, the data transmission path is formed by at least one optical fiber line.

In an embodiment, the limiter unit is an optical filter, with the wavelength range of the pass band of the optical filter being limited in a user-specific manner.

In an embodiment, the limiter unit includes a photoreceiver which converts an optical transmission signal into an electrical base band, and further includes an electrical bandwidth limiter and an electro-optical converter.

In an embodiment, the limiter unit is a polarization mode dispersion emulator.

In a further embodiment of the present invention, a method is disclosed for providing data transmission capacity on a data transmission path disposed between at least one transmit unit and at least one receive unit, wherein a data stream exchanged on the data transmission path is limited in a user-related manner.

In an embodiment of the method, wavelengths of the data stream can be limited in a user-related manner.

In an embodiment of the method, the transmission signal is an optical signal which is converted into an electrical base band, and limitation of the electrical base band is then carried out.

In an embodiment of the method, the data rate of the data stream is limited in a user-related manner using polarization mode dispersion.

The present invention offers the advantage that the data transmission capacity is limited depending on the requirements of a lessee, and a leasing price appropriate to the service thereby can be defined. Moreover, the present invention offers the advantage that it can be achieved through relatively simple means.

Additional features and advantages of the present invention are described in, and will be apparent from, the following Detailed Description of the Invention and the Figures.

### BRIEF DESCRIPTION OF THE FIGURES

FIG. 1 shows a block diagram with a limiter unit.

FIG. 2 shows a further design of a limiter unit built into an optical fiber transmission path.

FIG. 3 shows a further design of a limiter unit integrated into an optical fiber transmission path.

### DETAILED DESCRIPTION OF THE INVENTION

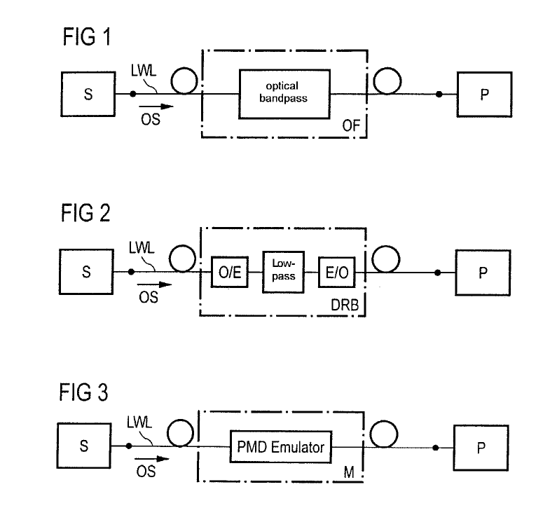

FIG. 1 shows a block diagram with a targeted limitation of the optical bandwidth. In this exemplary embodiment, an optical filter OF is inserted into an optical fiber transmission path, so that the optical transmission is restricted to a specific wavelength range or a wavelength division multiplex operation is prevented. This design form can be used to prevent dense wavelength division multiplex DWDM operation. Optical fibers include a number of “optical windows”, in which data transmission is possible.

In the case of single-mode optical fibers this entails, for example:

| | | |
|---|---|---|
| O-band | original band | 1310 +/− 50 nm |
| E-band | | 1410 +/− 50 nm |
| S-band | short band | 1490 +/− 30 nm |
| C-band | conventional band | 1530-1565 nm |
| L-band | long wavelength | 1575-1610 nm |

Below the O-band and above the L-band, attenuation of the optical fibers is so high that utilization would be possible with short transmission lengths only.

In a number of cases, the O-band is used for transmission. For many applications, only optical interfaces for the O-band are standardized for single-mode optical fibers; for example, in a Gigabit Ethernet.

In multiple wave operation on optical fibers, signals with different optical mid- frequencies (wavelengths) are transported simultaneously on one optical fiber. Each wavelength transports one channel, whereby the channels transport totally independent signals. At the end of the optical fiber path, the channels are separated with the aid of optical filters. Here, the following types of wavelength division multiplex operation are distinguished:

WDM Wavelength division multiplex: e.g., one channel in the O-band and in the C-band are in each case simultaneously transmitted.

CWDM Coarse WDM, from the O-band to the L-band, a total of several channels are simultaneously transmitted.

DWDM Many channels in the C-band and the L-band are simultaneously transmitted, currently in each case around 80 channels per band, with a channel spacing of 50 GHz (approx. 0.4 nm).

The limiter unit shown in FIG. 1 uses optical filters, with which the aforementioned wavelength division multiplex operation WDM, CWDM and WDM on dark fiber optical fiber paths can be restricted.

In FIG. 2, a circuit arrangement to limit the data rate on an optical fiber transmission path is inserted into an optical fiber transmission path LWL. This circuit arrangement has a broadband limiter including a photoreceiver, which converts the transmitted signal into the electrical base band, a broadband limiter (implemented by, e.g., electrical low-pass or bandpass filtering), and a transmitter, which retransmits the bandwidth-limited signal with the aid of a laser. Instead of the additional electrical filtering, a narrowband photoreceiver or transmitter also can be used.

An optical photodetector, such as an O/E converter, is located at the input of the data rate limiter DRB in FIG. 2. The changes in the optical power of the envelope of the optical signal are mapped into a photo current and, therefore, into an electrical signal. The quality of the time signal and spectrum of this electrical signal then corresponds, approximately, apart from inaccuracies in the mapping of the modulator and the receiver and distortions on the optical fiber path, to the modulation signal in the transmitter. If this electrical signal is then, for example, limited in its bandwidth by an electrical low-pass or bandpass filter, distortions occur which increase proportionally to the ratio of the transmitted data rate to the upper limit frequency of the electrical filter. The distorted electrical signal is again applied to the optical fiber path with an optical transmitter formed, for example, via an E/O converter. As a result of the distortions, the bit error probability increases on the photoreceiver at the end of the optical fiber path and, with a corresponding selection of the upper limit frequency of the electrical filter in the bandwidth limiter, the transmitted signal thereby becomes unusable.

The selection of the upper limit frequency of the electrical filter in the data rate limiter DRB essentially depends on the agreed maximum tolerable data rate and the data rate at which the restriction is intended to reliably take effect. Since a signal with the agreed data rate is not intended to be distorted, the bandwidth of the filter should not be selected as too narrow.

One advantage of this circuit design lies in the limitation to a relatively low data rate up to around one Gbit/s. A further advantage of this data rate limiter DRB is that wavelength division multiplex operation can be prevented.

Further variants of this design variant shown in FIG. 2 could be such that the band limiter acts at the permitted data rates as a 2R or 3R regenerator, thereby effecting signal improvement. In particular, a bandwidth limiter also may have a power-tracking function; i.e., the output power is always set according to the input power, thereby preventing any corruption of the transmission path diagram of the optical fiber path.

In the design variant shown in FIG. 3, a PMD emulator is used as the data rate limiter. This PMD emulator is used, in particular, in optical fiber transmission paths with single-mode optical fibers. In a single-mode optical fiber, 2 linear-polarized basic modes are polarized with propagation capability, orthogonally polarized in relation to one another. If the cylinder symmetry of the fibers is ideal, these modes are degenerated; i.e., they have the same propagation speed. Each polarization state in the fiber can be described by a superimposition of these two modes. Due to the possible inaccuracies in the manufacture of an optical fiber, or in the event of bending or mechanical pressure on the installed fiber, the aforementioned cylindrical symmetry of the fiber will no longer exist. The propagation speed of the two modes is then different, the fiber becomes double-refracting and, in the case of long optical fiber paths, the differential group delay may attain the order of magnitude of one bit period of the transmission signal. This results in widening of the transmitted pulses and, therefore, signal distortion. This effect is referred to as polarization mode dispersion PMD and is an unwanted effect which occurs, in particular, at high data rates; i.e., from 10 Gbit/s.

The distortion of the signal is dependent not only on the size of the differential group delay, but also on the ratio of the optical power in the two modes. However, the double-refracting characteristics of the optical fiber path change along the length of the path, not the least because the path includes a number of spliced fibers.

In the embodiment shown in FIG. 3, a module M for polarization mode dispersion is inserted into the optical transmission path, in particular with the use of single-mode optical fibers, so that a bandwidth restriction corresponding to the leasing conditions of the fixed-network operator is enabled. Since the natural mode dispersion of the fiber is not sufficient, an artificial polarization mode dispersion is generated in the module shown in FIG. 3. This polarization mode dispersion which is generated to restrict the bandwidth could be achieved, e.g., with the aid of polarization-receiving fiber or discrete double-refracting elements.

Although the present invention has been described with reference to specific embodiments, those of skill in the art will recognize that changes may be made thereto without departing from the spirit and scope of the present invention as set forth in the hereafter appended claims.

1. A system for providing data transmission capacity on a data transmission path, comprising:
at least one transmit unit;
at least one receive unit, wherein the data transmission path is disposed between the at least one transmit unit and the at least one receive unit; and
at least one limiter unit provided between the at least one transmit unit and the at least one receive unit, wherein the limiter unit is supplied with a data stream exchanged between the at least one transmit unit and the at least one receive unit and limits the data transmission capacity in a user-related manner.

2. A system for providing data transmission capacity on a data transmission path as claimed in claim 1, wherein the data transmission path is formed by at least one optical fiber line.

3. A system for providing data transmission capacity on a data transmission path as claimed in claim 2, wherein the limiter unit is an optical filter and a wavelength range of a pass band of the optical filter can be limited in a user-specific manner.

4. A system for providing data transmission capacity on a data transmission path as claimed in claim 2, wherein the limiter unit includes a photoreceiver which converts an optical transmission signal into an electrical baseband, and further includes an electrical bandwidth limiter and an electro-optical converter.

5. A system for providing data transmission capacity on a data transmission path as claimed in claim 2, wherein the limiter unit is a polarization mode dispersion emulator.

6. A method for providing data transmission capacity on a data transmission path, the method comprising the steps of:
providing that the data transmission path be disposed between at least one transmit unit and at least one receive unit; and
limiting a data stream exchanged on the data transmission path in a user-related manner.

7. A method for providing data transmission capacity on a data transmission path as claimed in claim 6, wherein wavelengths of the data stream can be limited in a user-related manner.

8. A method for providing data transmission capacity on a data transmission path as claimed in claim 6, wherein the transmission signal is an optical signal which is converted into an electrical baseband, and limitation of the electrical baseband is then carried out.

9. A method for providing data transmission capacity on a data transmission path as claimed in claim 6, wherein a data rate of the data stream is limited in a user-related manner using polarization mode dispersion.
